(19) United States
(12) Patent Application Publication
(10) Pub. No.: US 2003/0117261 A1
(43) Pub. Date: Jun. 26, 2003

(54) Universal transmitter for controlling multiple keyless entry systems

(76) Inventor: Tracy Gunsch, Sierra Vista, AZ (US)

Correspondence Address: Tracy Gunsch, 4565 Princess Drive, Sierra Vista, AZ, 85635, US

(21) Appl. No.: 10/033,431

(22) Filed: Dec. 26, 2001

(51) Int. Cl. G06F 7/04

(52) U.S. Cl. 340/5.25; 340/5.72

(57) ABSTRACT

A universal keyless entry transmitter for sending signals to multiple keyless entry systems. It includes a means for selecting any of several controlled devices and a means for entering transmission codes for each of those devices. In this embodiment, the transmitter is a key chain fob with buttons (26) for all the standard commands typically found on keyless entry systems, especially vehicle security systems. The device has a switch (22) for selecting which device is to be controlled, a fingerprint reader (32) for user identification and a programmable microprocessor (49) for storing user information and signal information for controlling devices. It contains an output display (24), and a menu system for programming signal information and user authorizations.

### CROSS REFERENCE TO RELATED APPLICATIONS

Not Applicable

### BACKGROUND

1. Field of the Invention

This invention relates generally to keyless entry transmitters frequently used for, but not limited to, vehicle entry systems. This invention relates specifically to a programmable transmitter that can provide entry and other functions to multiple keyless entry systems.

2. Description of the Prior Art

Many cars and trucks now come equipped with keyless entry systems for security and convenience. These typically take the form of a pocket-sized fob transmitter with several pushbuttons that lock and unlock doors and perform other functions through encoded radio-frequency (RF) signals transmitted to a vehicle-installed receiver. These encoded signals employ various formats, based on the manufacturer, to include bit timing, word length, pulse width, modulation frequency and header and trailer pulse formats, all of which are interpreted by the receiving device to allow or deny access. Besides locking and unlocking doors, signal codes may be defined, depending on the implementation, to activate and deactivate alarms, open a trunk or hatch, start and stop a vehicle's engine and honk the horn in emergencies.

In addition to vehicles, implementations of keyless entry systems exist for building entrances, most frequently for home or garage doors and storage sheds, replacing or augmenting standard key and deadbolt locks. With the increased numbers of vehicles with keyless entry systems and with the emergence of other keyless entry systems, it is not uncommon for a user to carry two or more fob transmitters on a key chain. The size and bulk of these fobs makes this inconvenient.

This present invention addresses the desire to combine the functionality of several keyless entry transmitters into one programmable universal transmitter. Additionally, this invention provides security to the owner by limiting the use of the universal transmitter to registered users only, through an authorization mechanism. Although there are many patents and other references related to the problems of keyless entry, none address the problems solved by this invention. For example, U.S. Pat. No. 6,216,502 to Cannella, et al, discloses a keyless entry system for deadbolt locks and U.S. Pat. No. 5,609,051 to Donaldson discloses a system to convert key locks to keyless entry systems. Neither patent addresses the need to combine the transmitters into a single all-purpose unit.

U.S. Pat. No. 5,864,297 to Sollestre, et al, discloses a user-reprogrammable receiver for use when the owner's transmitter is lost or stolen, but does not discuss a programmable transmitter. That patent also does not adequately protect the owner from theft of the vehicle because a thief could easily steal the vehicle before the owner realizes his transmitter is missing or has occasion to reprogram the receiver.

U.S. Pat. No. 5,991,431 to Borza, et al, discloses an authorization system for restricting use of a computer system to registered users by the identification from a fingerprint sensor incorporated into the computer's mouse. This patent fails to disclose a means to limit use of a keyless entry transmitter.

U.S. Pat. No. 4,774,511 to Rumbolt, et al, discloses a universal remote control unit for appliances, using an infrared transmitter. It does not address using a radio signal for keyless entry systems, and does not disclose a means for securing the device from unauthorized access.

U.S. Pat. No. 6,031,465 to Burgess discloses a keyless entry system that requires an identification code be entered to authorize use of the transmitter. This identification code protects the device from unauthorized use, but it is cumbersome to use regularly and fails to provide a means to authorize users only during certain time frames.

U.S. Pat. No. 6,271,745 to Anzai, et al, discloses a keyless entry system that uses biometric information to identify the user of a vehicle and grant authorization of certain vehicular functions. This patent discloses vehicle-mounted biometric readers, and does not disclose the use of a transmitter with biometric reader, which could be used for multiple entry systems. This patent also fails to provide a means to authorize users only during certain time frames.

### SUMMARY OF THE INVENTION

The present invention is a universal keyless entry transmitter that can transmit signals to multiple keyless entry systems. It includes a means for selecting any of several controlled devices and a means for entering transmission codes for each of those devices. In the preferred embodiment, the physical device is a key chain fob much like those common to vehicle keyless entry systems. The fob contains several buttons to encompass standard transmitted commands.

The preferred embodiment includes a user interface consisting of a menu system, programmable buttons and a liquid crystal display (LCD) for displaying menu commands and options. Within the menu system, the user can define the different keyless entry systems, to include transmission codes, button actions, authorized users, and time frames for authorized use. In this manner, different users can be granted varying levels of privilege and authorization. This is especially useful to provide limited use for children or valets.

Another object and advantage is an authentication means, which, in the preferred embodiment, is a biometric fingerprint reader on the rear of the fob transmitter. This fingerprint reader is used to identify users of the device, allowing for the various levels of authorization defined by user. This fingerprint reader also serves as an effective theft-deterrent. The transmitter cannot be used by a thief because the fingerprint scanner will not recognize the thief as an authorized user.

An additional object and advantage of the system is a valet mode, whereby the authentication means can be overridden for a time to grant temporary use to a friend or a valet.

The menu system has further objects and advantages in its group listings, defining different groups of users with like permissions. This greatly aids in the programming of the device.

Further objects and advantages of this invention will become apparent from a consideration of the drawings and ensuing description.

### DRAWING FIGURES

FIG. 1 shows the front view of universal keyless entry transmitter with a proposed layout of required buttons.

FIG. 2 shows the four main components of the transmitter and how they interconnect.

FIG. 3 shows the rear view of the universal transmitter.

FIGS. 4A and 4B show the circuit board and its primary features, front and back, respectively. The complete circuitry layout of the circuit board is beyond the scope of this patent.

FIGS. 5A and 5B show the rubber insert and front shell respectively.

FIG. 6 shows the inside of the rear shell.

FIGS. 7A, 7B and 7C are flowcharts showing the primary operational logic of the universal transmitter's microprocessor.

### REFERENCE NUMERALS IN DRAWINGS

20 Front Shell

22 Device Selector Switch

23 Shell Slot for Selector Switch

24 Menu Display Screen

26A-H Input Buttons

26A Open/Unlock Button

26B Close/Lock Button

26C Start (engine) Button

26D Stop (engine) Button

26E Trunk Open Button

26F Horn/Panic Button

26G Menu Button

26H Enter Button

28 Arrows showing button functions when in menu system

30 Rear Shell

32 Fingerprint Sensor

33 Fingerprint Sensor Circuitry

34 Reset Button Slot

35 Reset Button

36 Groove for Forefinger

38 Battery slot

40 Circuit Board

42 Ribbon Cable connecting fingerprint sensor circuitry (33) to circuit board (40)

44 and 44A Ribbon cable connection points

45 Transmitter

46 Sensors to detect button presses

48 Battery connection

49 Microprocessor

50 Rubber Insert

52 Slot for Display Screen

54 Slot for Selector Switch

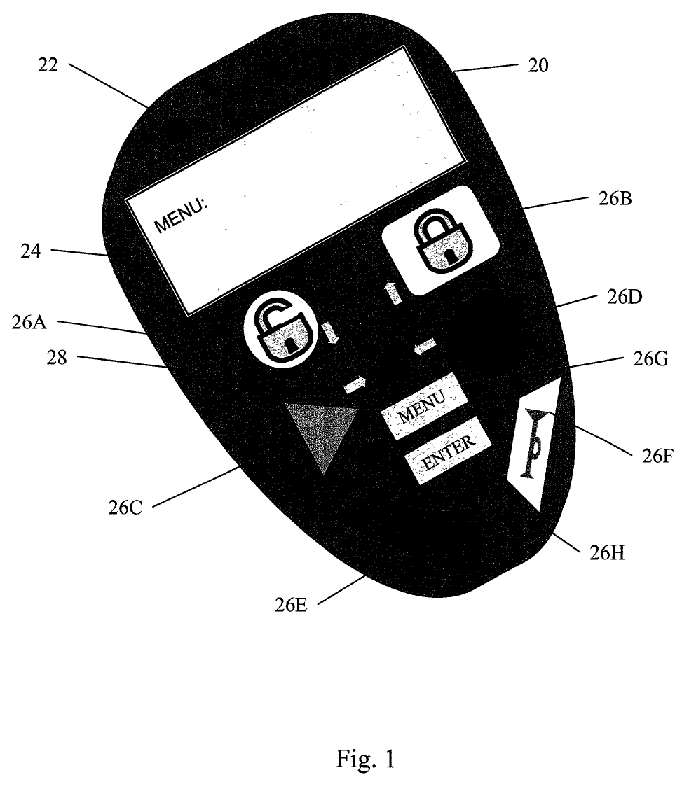

### DESCRIPTION—FIGS. 1-6, PREFERRED EMBODIMENT

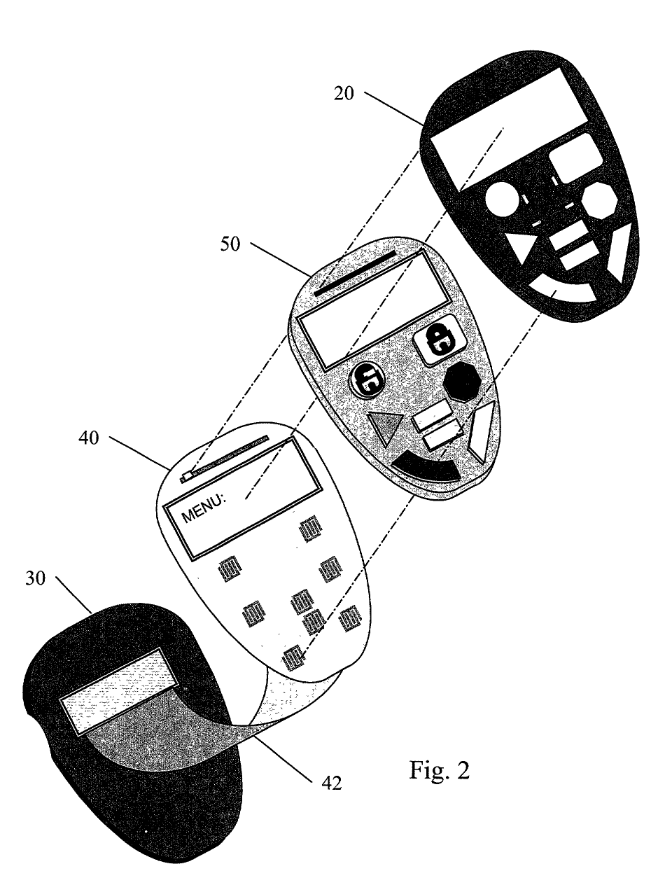

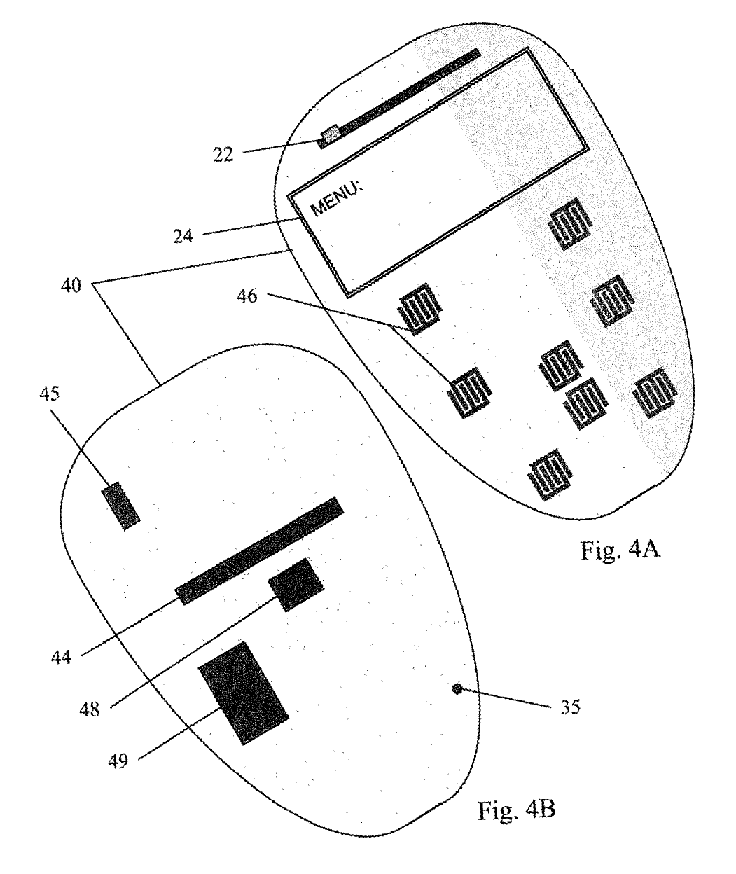

A preferred embodiment of the present invention is illustrated in FIGS. 1-6. It takes the form of a typical key chain fob, with buttons, a text display and a biometric fingerprint reader. FIG. 1 shows the overall view of the preferred embodiment. FIG. 2 shows the interconnection of the main components, a plastic shell 20 in front, a rubber insert 50 with buttons 26A-H that fit in the slots of the front shell 20, a circuit board 40, and a rear shell 30. The heart of the invention is the circuit board 40 shown with its major components in FIGS. 4A and 4B. These include sensors 46 for reading button inputs, a microprocessor 49 containing a menu system for controlling operations, a transmitter 45 for sending commands to keyless entry systems, a switch or selector 22 for choosing which keyless entry system to communicate with, and an output or interface 24 for displaying information to the user. The type of output device most common for this kind of function is a liquid crystal display (LCD), though other embodiments exist. Additional components on the circuit board are: a connection point 44 for a ribbon cable 42 connecting to the fingerprint reader circuitry 33; a battery connection node 49; a reset button 35 for clearing all settings; and miscellaneous small circuitry and electronics not shown on the drawings.

FIG. 1 shows the assembled device, as it would be typically operated. A series of buttons, 26A-H, are used to input commands to the microprocessor. The specific functions of these buttons are: 26A, open or unlock; 26B, close or lock; 26C and 26D, start and stop, usually for vehicle engines; 26E, open trunk or other programmed function; 26F, honk horn or other programmed function; 26G, access the menu; and 26H, enter/return. Within the system menus, these buttons can take on other roles, specifically for navigation within the menu. They can also be programmed to perform functions other than these defined.

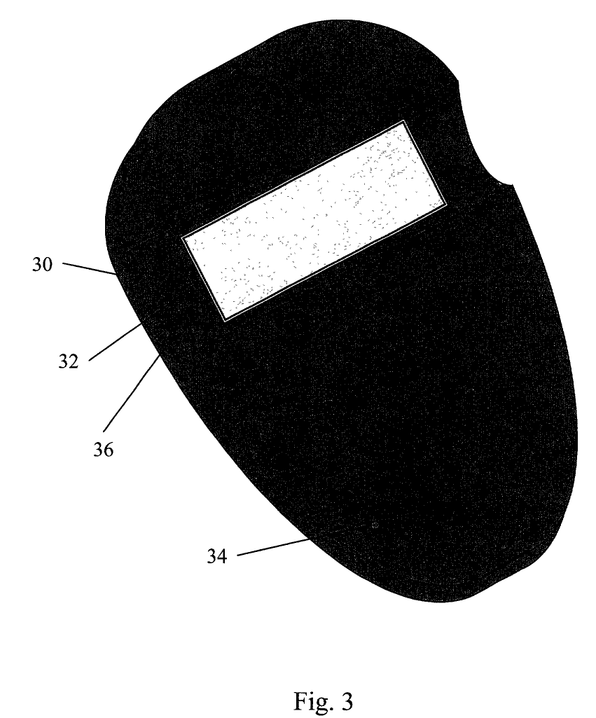

FIG. 3 shows the rear view of the assembled device. This shows a slot or groove 36 for comfortably resting the user's forefinger, and a sensor or reader 32 for reading a fingerprint from the user's left or right forefinger, or other digit as desired. A small hole 34 offers access to the reset button 35 for resetting the entire system to factory defaults, necessary in the extreme case where the menu system cannot be accessed any other way.

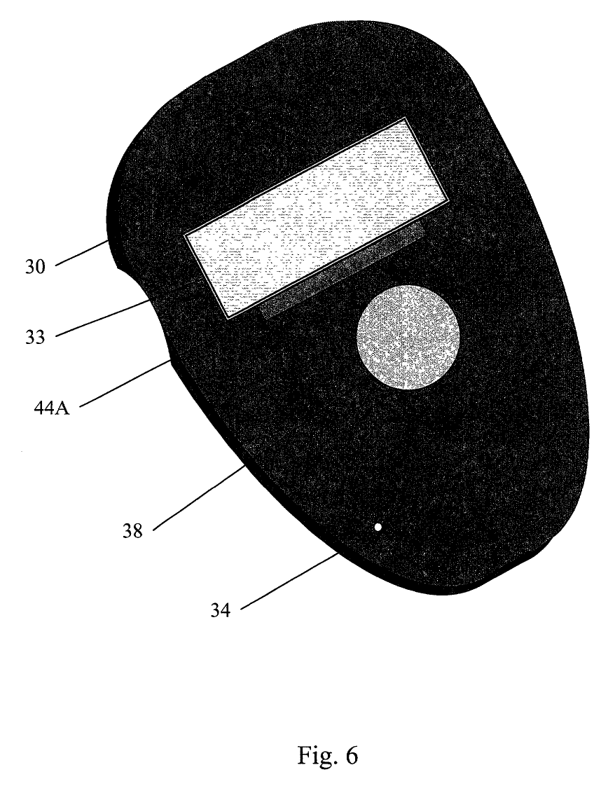

FIG. 6 shows the inside view of the rear shell which contains a slot 38 for a replaceable battery, the circuitry 33 necessary for the fingerprint reader, and a connection point 44A for a ribbon cable to the circuit board 40. The rear shell 30 has a ridge around the outer edge that fits snugly inside the front shell 20 keeping the assembly together.

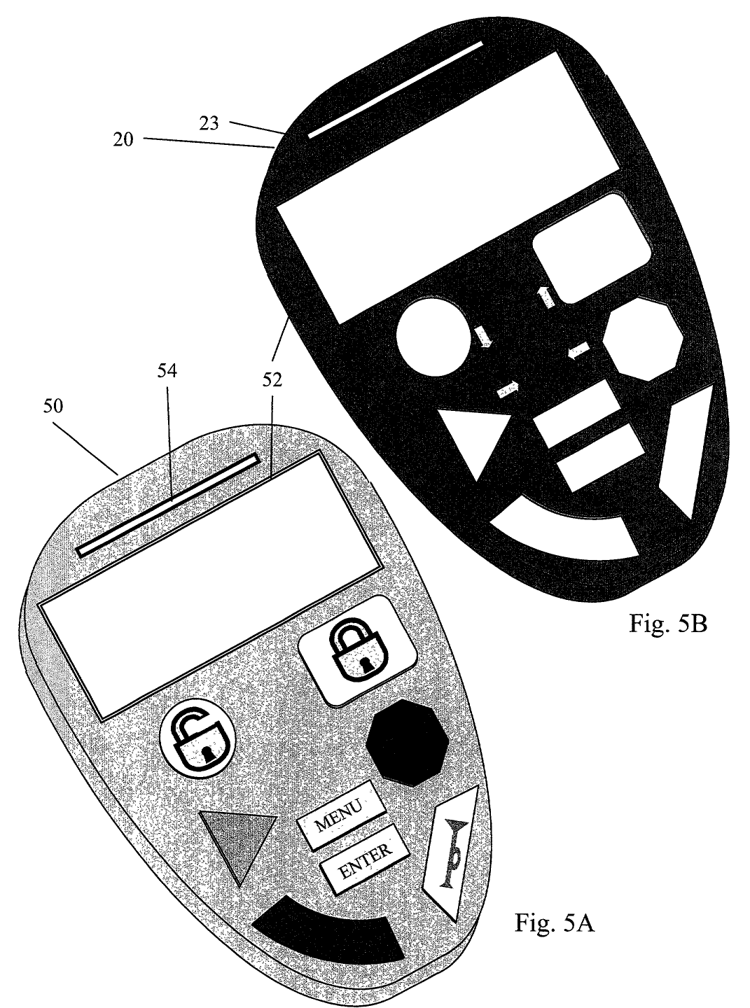

FIG. 5A shows the rubber insert 50 in more detail. This is a flexible, waterproof material like that found on most keyless entry fobs today. The buttons 26A-H all have an electrically conductive surface on their rear side facing the circuit board 40. When a user presses a button, this conductive surface touches one of the circuit board sensors 46 completing an electrical circuit that generates a signal to the microprocessor 49. FIGS. 5A and 5B also show slots where the LCD and the device selector switch 22 project through from the circuit board.

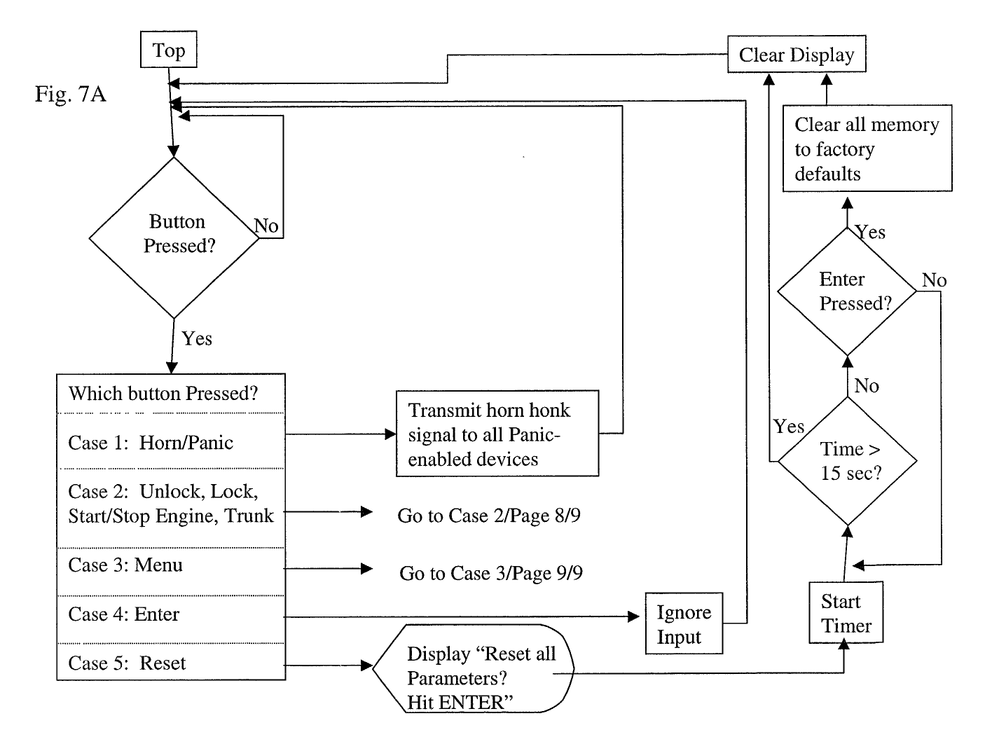

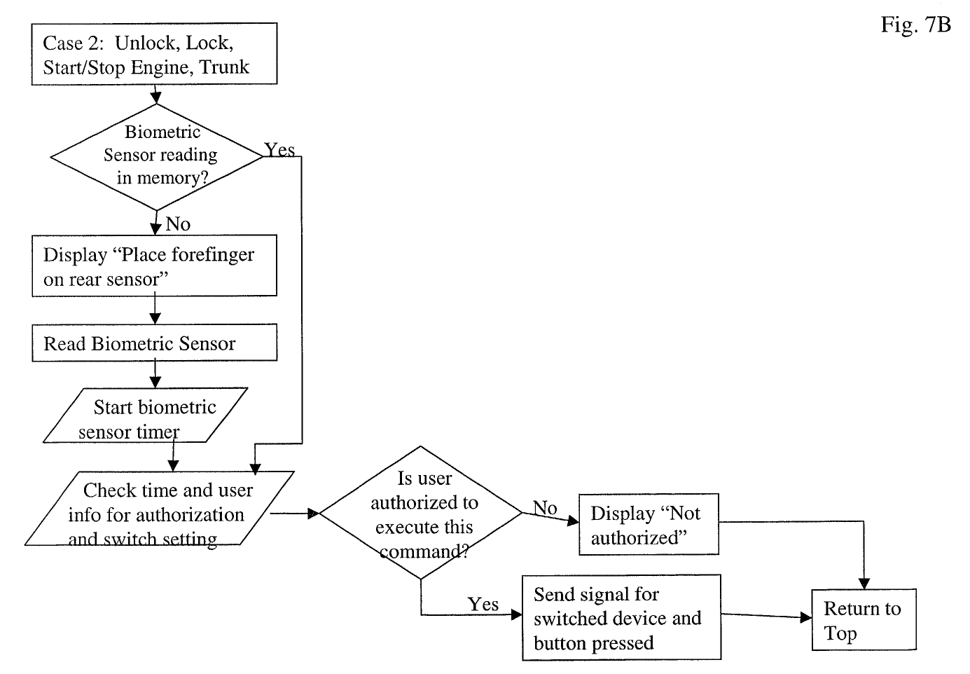

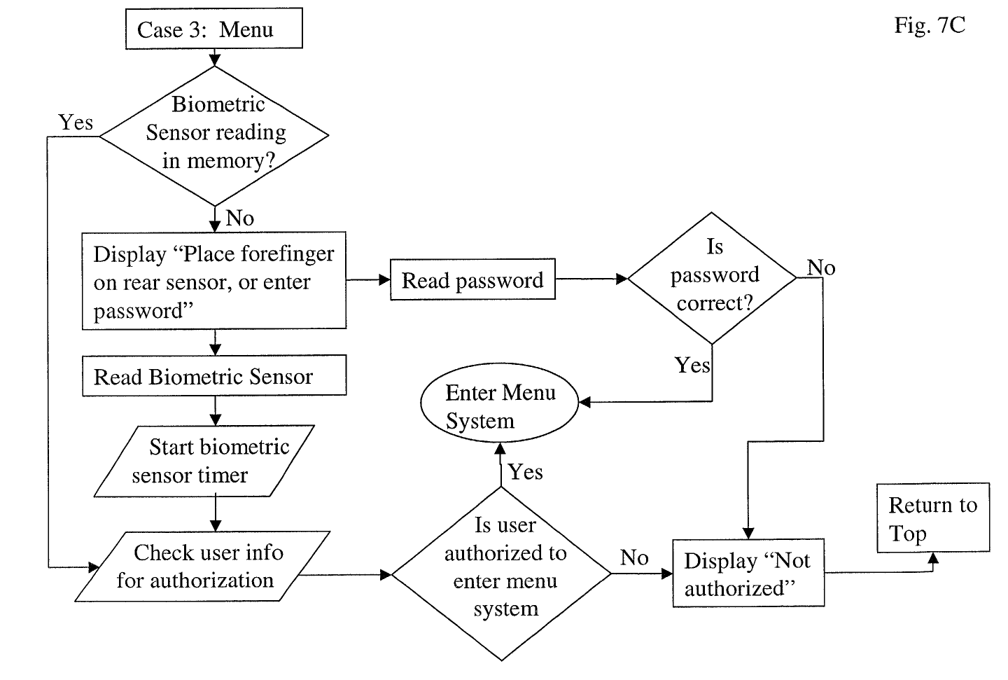

### OPERATION—FIGS 1, 7, 8

Physical Layout:

In the preferred embodiment, the universal transmitter has buttons for every major function available on regular keyless entry transmitters. These buttons include UNLOCK, LOCK, OPEN TRUNK, START ENGINE, STOP ENGINE, and PANIC, which activates the horn in case of emergency. Other buttons to include on the transmitter are MENU and ENTER. Some of the buttons can be reused as arrow keys when in the menu system. The Universal Transmitter has a Liquid Crystal Display (LCD) and a Menu system for programming, described below. The transmitter also has a numerical switch on the front or side to move between devices; #1 for vehicle 1, #2 for vehicle 2, #3 for a home entry system or for a third vehicle, #4 for a garage door, etc. On the rear of the fob transmitter is a fingerprint reader for user authentication. FIG. 1 shows the proposed key layout.

Entry Codes:

Keyless entry systems use a coded radio signal to gain access to an asset, usually a vehicle. This signal is embedded into a specific transmitter by the agency responsible for the keyless entry system, usually an automobile dealership or an alarm system installer. These signal codes define many criteria about the format of the signal, including the frequency and data transmitted between the transmitter and the keyless entry system. These same signal codes will be stored in the memory of the Universal Transmitter, and will each be assigned to a selector switch setting.

Getting these signal code formats into the Universal Transmitter will require coordination with the security system manufacturers. The Universal Transmitter's menu system will have options for setting whatever parameters are required for use with various manufacturer's keyless entry systems. Once the signal format is programmed into the memory, the transmitter will beam the proper signal when the switch setting is set to that asset and the appropriate button is pushed. The system of signal code formats for the Universal Transmitter will differ from that of Universal TV/VCR remotes in that the codes will likely not be published publicly. The practice right now is for vehicle manufacturers to program keyless entry transmitters at the dealerships, preventing vehicle codes from being known by the users. This process could be extended for the Universal Transmitter, where users could get the proper code for their specific vehicles from the car dealerships. In this way, the access codes would be kept as secure as they now are. This could similarly be extended to home or other keyless entry systems.

Another method was considered and discounted for obtaining signals for the universal transmitter. This method, also imitated from the Universal TV/VCR remote, is to build a learning capability into a transmitter so that the Universal Transmitter could be placed back to back with a standard transmitter from a dealership. The Universal Transmitter could then “listen” as the standard transmitter sends its signals out, and the Universal Transmitter could “learn” the codes, repeating them as needed. The flaw with this approach is that a thief could easily intercept these codes on another Universal Transmitter and steal cars by hiding in parking lots. This is not a danger for TV/VCR remotes, because hostile entities are not likely to steal infrared (IR) remote signals and indiscriminately change a user's TV channels, but it is a very real concern for vehicle and home entry systems. Also, the signal range on a keyless entry transmitter is much greater than an IR remote, making it easier to eavesdrop on signals. Because of this security risk, this method of obtaining signals is not considered appropriate.

Menu System:

In the preferred embodiment, the Universal Transmitter will have a Menu System for programming the transmitter and displaying information on the LCD. The menu system will have password protection to protect access and contain settings for each of the receiving devices. The user would select the asset to be programmed, using the selector switch, and enter the password for access into the menu system. Once in, the settings for that asset could be changed. The settings for that asset include the signal code format for accessing the asset, and the list of authorized users of that asset. Additional settings could include a time range for authorized use; for instance, allowing a teenage child to have authorization to use a vehicle only during certain hours of the day.

The authorized user list would be tied to the fingerprint scanner. All authorized users would have their fingerprints (at least two) scanned and stored in the transmitter's or secure asset's memory. The menu system can then define which user is allowed to perform which functions. User's unrecognized by the system would be denied access, i.e. pressing buttons would have no effect. An override option would be included in the menu system so that the fingerprint authorization could be temporarily disabled. This would be beneficial for allowing a valet parking attendant or a friend to use the vehicle without requiring a fingerprint enrollment process. This override option can only be enabled by an authorized user.

The menu system would also govern enrolling users, using the fingerprint reader to identify different users. The display could also be used to show information such as the current date and time.

Menu System Configuration:

In the preferred embodiment, the menu system will have the capabilities mentioned above, and additional capabilities can be added as needed. The primary menu system configuration will contain three submenus; to wit, User Registration, Device Configuration, and Overall Settings.

Within the User Registration Submenu will be options for registering user fingerprints, usually of the left and right forefingers; assigning permissions to users; assigning administrator privileges; and assigning time restrictions for users. Also, user groups should be available for grouping users with like permissions together, thereby simplifying the administration process.

The Overall Settings Submenu will contain, at a minimum, options to set date and time (including Daylight Savings Time) and an option to set a numeric password for accessing the menu system. The numeric password is recommended to be 5 characters long and after 20 failed attempts to access the menu system, the transmitter should revert to factory default settings, clearing all configuration memory. In this way, the owner/administrator of the device can access the menu system in case of a difficulty with the biometric sensor, but a thief could not likely gain unauthorized access to secured assets. The clearing of configuration memory will remove all signal format information, preventing access to all secured devices. An additional command in this menu will enable a temporary “Valet Mode,” wherein the authentication steps are bypassed for a designated period of time while the transmitter is in the possession of a friend or valet.

The third submenu, Device Configuration, should contain all of the settings specific to the devices controlled by the universal transmitter. These include, but are not limited to, setting a frequency code for each receiving device, or, less preferably, a frequency code for each individual function on the receiving device; selecting enabled buttons: trunk, panic/horn, start, stop, unlock and lock; assigning other functions to a button (e.g. pressing the trunk button sends a ‘turn off lights’ signal); and defining a device name.

The present invention may be embodied in other specific forms without departing from the spirit or essential characteristics thereof The presently disclosed embodiments are therefore to be considered in all respects as illustrative and not restrictive, the scope of the invention being indicated by the appended claims, rather than the foregoing description, and all changes which come within the meaning and range of equivalency of the claims are, therefore, to be embraced therein.

### ADDITIONAL EMBODIMENTS

The preferred embodiment uses a fingerprint reader to uniquely identify the user. Other security means can be used to identify the user, such as voice recognition, iris scan, or other biometric means. Also, numerical passwords can be used, though passwords are inherently not as secure as biometric identification. Another embodiment eliminates the use of buttons, but instead uses a touch screen for display and user input.

### ALTERNATIVE EMBODIMENTS

Many alternative embodiments, too numerous to describe, exist which do not change the spirit or essential characteristics of the invention and are thus considered to be within the scope of this invention. For example, the button layout can be altered as can the number and default functions of those buttons. The selector switch can be replaced with another means for selecting the controlled device. The layout of the menu system and the type of display device can be very different than described in the preferred embodiment. The physical means of reading button inputs using electrical connectivity can be replaced with a different means to input information. The authentication method can also be changed, as described above, using a different biometric technique, or a non-biometric system like a password, or even using a combination thereof

### CONCLUSION, RAMIFICATION, AND SCOPE

Thus the reader will see that the universal transmitter of this invention provides an efficient means to send commands to several keyless entry systems with one device. In addition, it provides a greatly enhanced security capability over existing keyless entry transmitters by authenticating users before allowing commands to be sent. It allows the user to define time and user restrictions to given assets, while still allowing the convenience of lending the keys to another through its valet mode.

Although the description above contains many specificities, these should not be construed as limiting the scope of the invention but as merely providing implementation details of the present preferred embodiment. Many alternative embodiments, too numerous to describe, exist with respect to button layout, button functions, physical means to read button inputs, device selector switch configuration and menu system layout. None of these changes the spirit or essential characteristics of the invention. Thus, the scope of the invention should be determined by the appended claims and their legal equivalents, rather than by the examples given.

I claim:

1. A programmable keyless entry transmitter for use with multiple vehicles or other devices equipped with keyless entry receivers; the transmitter consisting of:
a programmable memory for storing signal format information for controlled devices;
a means to select a particular receiver device to be controlled;
a means of selecting a particular command to be transmitted; and
a transmitting antenna for sending commands to keyless entry receivers.

2. The transmitter of claim 1 further including means to program said transmitter with frequency and signal information specific to multiple keyless entry systems

3. The transmitter of claim 1 further including a means to authenticate users to prevent unauthorized use or access of the transmitter

4. The transmitter of claim 1 further including a means to limit authorized use of the transmitter to a range of pre-selected actions
